(19) United States
(12) Patent Application Publication
(10) Pub. No.: US 2018/0290104 A1
(43) Pub. Date: Oct. 11, 2018

(54) INTELLIGENT AIR PURIFIER

(71) Applicant: FUH-CHENG JONG, TAINAN CITY (TW)

(72) Inventor: FUH-CHENG JONG, TAINAN CITY (TW)

(21) Appl. No.: 15/483,163

(22) Filed: Apr. 10, 2017

(51) Int. Cl. B01D 53/30; F24F 3/16

(52) U.S. Cl. CPC B01D 53/30; F24F 3/1603

(57) ABSTRACT

An intelligent air purifier includes a machine body, a mobile unit, at least one sensor, and a control unit. The machine body has an air inlet, a consumable substance, and an air outlet. The air is sucked from the air inlet, purified by the consumable substance, and discharged from the air outlet. The mobile unit is mounted to the machine body. The sensor is disposed on the machine body for detecting an air quality index of the air in a room. The control unit is communicated with the mobile unit and the senor through electrical signals. The control unit is preset with a pollution value. When the air quality index of the air at a position in the room is greater than the pollution value, the control unit controls the mobile unit to move the machine body to the position to purify the air.

### FIELD OF THE INVENTION

The present invention relates to an intelligent air purifier, and more particularly to an intelligent air purifier capable of detecting the air quality index of the air at a position in a room anytime and controlling a machine body to be moved or turned to the position, enabling an air inlet of the machine body to face the position for purifying the air quickly.

### BACKGROUND OF THE INVENTION

In recent years, the Asian region often suffers from haze. The suspended particles of the air will cause great harm to human health. From the data provided by the EPA (Environmental Protection Administration), it can be known when the concentration of suspended particles reaches 350 μg/m3, chronic bronchitis respiratory symptoms will increase and it will harm the patients with a chronic lung disease. The concentration of 230 μg/m3 will reduce the expiratory volume per second. The concentration of 150 μg/m3 will increase the frequency of asthma. Regarding the long-term effect of suspended particulates on human health, for adults, the concentration of 250 μg/m3 will increase the volume of phlegm; the concentration of 40 μg/m3 will increase respiratory diseases; the concentration of 180 μg/m3 will increase respiratory symptoms and lower the lung function; for children and adolescents, the concentration of 180 μg/m3 will increase respiratory diseases and lower lung function, the concentration of 85-195 μg/m3 will increase lower respiratory diseases. In addition to the above problems, it even causes allergies to adolescents and children, so an air purifier has almost become a necessary home appliance.

The existing air purifiers on the market can be classified into two types, one uses an electrostatic precipitation device to reduce suspended particles in the air; the other uses a dense filter to remove suspended particles in the air. No matter what consumable substance is used, the air purifier is always placed at one corner of a room, so the effect of air purification is limited to a certain area of the room. The other areas of the room can't be purified.

Taiwan Utility Model No. M531565 published on Nov. 1, 2016 discloses an “Air Cleaner”. The air cleaner includes a plasma generating device disposed at an air outlet of an extraction device. The other side of the plasma generating device is provided with an electrostatic precipitation device. The other side of the electrostatic precipitation device is provided an ozone removing device. Thereby, when in use, the air is drawn by the exhaust device, and the air is ionized by the plasma generating device in order to remove virus, bacteria, etc. in the air. Next, the electrostatic precipitation device is used to absorb dust and suspended particles in the air. Finally, the ozone removing device is used to remove the ozone generated from the ionized air and organic gases contained in the air, so that the air is really purified to prevent contaminants in the air from harming the human body.

However, the location of the air intake opening of the aforesaid patent is immovable and cannot change along with the location of the dirty air. The air intake opening may be changed manually to face the position of the air to be purified. This is troublesome and laborious.

Taiwan Patent No. 1555954 published on Nov. 1, 2016 discloses an “Air Cleaner”. The air cleaner includes a housing, an inlet, an outlet, a blowing device, a cleaning device, a movable grid plate, a horizontal rotation mechanism, a detecting unit, a control device, and so on. The control device detects the temperature difference between the floor and the ceiling by an infrared detector of the detecting unit. If the temperature difference between the floor and the ceiling is larger than the preset reference value, compared with the temperature difference lower than the reference value, the volume of the air blown upward is increased. Thereby, the air near the ceiling is agitated to circulate the air between the ceiling and the floor efficiently. Further, at least one of the number of revolutions of the blowing device and the horizontal rotation mechanism is controlled based on the detection result of the contaminants of the dirt detection device. That is, in this control, at least one of the rotational angle and the volume of the blown air is controlled based on the detection result of the contaminants. In this way, the volume and the direction of the air can be controlled sufficiently, and the air is blown toward the higher pollution level to give priority to purity the position. Therefore, it is possible to efficiently perform the most appropriate operation for air clean by detecting people and by detecting the dirt based on the detection result of both.

The air cleaner of the aforesaid patent obtains the operating information through the other air conditioning machine to change one of the air direction control, the air volume control and the air direction rotation control to increase the air volume and perform the air purification. However, the air cleaner is fixed at a position, so the area for the air to be purified is quite small. The air cleaner only purifies the air around the air cleaner and it cannot be used in a wide range of areas, so the use is not ideal.

Because of the current society with a low birth rate and the aged society, most people go out to work so no one is at home to know the home situations. It is easy for thieves and burglars to intrude a house. In the case of a fire, it is difficult to ensure the home safety. Accordingly, the inventor of the present invention has devoted himself based on his many years of practical experiences to solve these problems.

### SUMMARY OF THE INVENTION

In view of the shortcomings of the prior art, the primary object of the present invention is to provide an intelligent air purifier used for purifying air in a room. The intelligent air purifier comprises a machine body, a mobile unit, at least one sensor, and a control unit. The machine body can be moved or turned in the room. The machine body has at least one air inlet and at least one air outlet. The air is sucked from the air inlet and discharged from the air outlet. The machine body is provided with a consumable substance. The mobile unit is mounted to the machine body. The sensor is disposed on the machine body for detecting an air quality index of the air. The control unit is disposed in the machine body. The control unit is communicated with the mobile unit and the senor through electrical signals. The control unit is preset with a pollution value. When the air quality index of the air at a position in the room is greater than the pollution value, the control unit controls the mobile unit to move the machine body to the position and the air inlet faces the position to purify the air.

Preferably, the air inlet is disposed at a front side of the machine body. The air outlet is disposed at a rear side of the machine body. Two sides of the machine body, between the air inlet and the air outlet, are defined as a left side and a right side, respectively.

Preferably, the sensor includes a front sensor, a rear sensor, a left sensor, and a right sensor. The front sensor is disposed on the front side of the machine body corresponding in position to the air inlet for detecting the air quality index of the air before the air is sucked into the air inlet. The rear sensor is disposed on the rear side of the machine body corresponding in position to the air outlet for detecting the air quality index of the air purified by the consumable substance and discharged from the air outlet. The left sensor is disposed on the left side of the machine body for detecting the air quality index of the air at the left side of the machine body. The right sensor is disposed on the right side of the machine body for detecting the air quality index of the air at the right side of the machine body.

Preferably, the control unit compares a pre-purification datum of the air detected by the front sensor before the air is sucked into the air inlet with a post-purification datum of the air discharged from the air outlet and detected by the rear sensor to determine whether the consumable substance needs to be replaced or not.

Preferably, when the control unit determines that it is necessary to replace the consumable substance, the control unit controls a light emitting member to light up or blink or controls a sound generating member to generate a warning sound. The light emitting member and the sound generating member are disposed on the machine body, respectively.

Preferably, the control unit determines whether or not the air quality index of the air at the left side or the right side of the machine body is greater than the pollution value according to the air quality index detected by the left sensor and the air quality index detected by the right sensor, the air quality index of the air at the left side or the right side of the machine body is greater than the pollution value, the mobile unit is actuated by the control unit to move or turn the machine body left or right.

Preferably, the consumable substance is disposed in the machine body and located between the air inlet and the air outlet.

Preferably, the mobile unit is a wheel or a continuous track. The wheel or the continuous track is driven by an engine or a motor to move the machine body within the room through a belt, a belt pulley, a gear, a chain, or a pulley.

Preferably, the sensor is one of a dust concentration sensor, a PM2.5 sensor, a carbon dioxide concentration sensor, a carbon monoxide concentration sensor, an ammonia concentration sensor, a sulfur dioxide concentration sensor, a TVOC (Total Volatile Organic Compounds) concentration sensor, a hydrogen sulfide concentration sensor, an alcohol concentration sensor, a formaldehyde concentration sensor, a chlorofluorocarbon concentration sensor, a vehicle exhaust concentration sensor, a combustible gas concentration sensor, a liquefaction petroleum gas concentration sensor, and a methane concentration sensor, or a combination thereof.

Preferably, the control unit is a single chip control module, a transistor control module, or a computer control module.

Preferably, a fan is provided between the air inlet and the air outlet. The fan is communicated with the control unit through electrical signals. The control unit controls a rotational speed of the fan according to the air pollution index of the air to change a suction force of the air inlet. The control unit controls a movement speed of the mobile unit to change a purification rate for the air.

Preferably, the intelligent air purifier further comprises a monitoring unit. The monitoring unit is communicated with the control unit through electrical signals. The monitoring unit includes a photographic member and/or an audio member for photographing and/or recording in the room. The control unit transmits a captured image and/or a recorded sound to a remote electronic device. The photographic member and/or the audio member are disposed on the machine body.

Preferably, the control unit is provided with a communication member. The communication member is a network, a Bluetooth, or a Wi-Fi for transmitting the captured image and/or the recorded sound to the remote electronic device.

Preferably, the intelligent air purifier further comprises a power supply unit. The power supply unit is disposed in the machine body. The power supply unit is electrically connected with the mobile unit, the sensor, the control unit, and the monitoring unit, thereby supplying a required power to the mobile unit, the sensor, the control unit, and the monitoring unit.

According to the aforesaid technical features, the present invention has the following advantages:

1. The intelligent air purifier can continuously detect the air quality index of the surrounding air of the machine body. If the air quality index at any position is greater than the pollution value, the control unit can immediately control the machine body to move or turn towards the location of the polluted air, and the air inlet faces the position to purify the air quickly.

2. The intelligent air purifier can detect the air quality index of the air before the air is sucked into the air inlet and the air quality index of the air purified by the consumable substance and discharged from the air outlet to make a comparison. After comparison, if the comparison result is greater than a replacement standard value, the control unit will control the light emitting member to light up or blink, and controls the sound generating member to generate a warning sound, thereby notifying the user of replacing the consumable substance, such that the consumable substance can maintain the effect of purifying the air for a long period of time.

3. The photographic member and the audio member are used for photographing and recording a sound in a room anytime. The captured image and/or the recorded sound may be transmitted to the user's smart home to prevent the intrusion of a thief or a fire, so that the user can know and monitor the home situations and ensure the home safety.

4. The control unit controls the rotational speed of the fan according to the air quality index of the air, and controls the movement speed of the mobile unit, thereby change the purification rate for the air in order to purify the air rapidly.

### BRIEF DESCRIPTION OF THE DRAWINGS

FIG. 1 is a front perspective view of the present invention;

FIG. 2 is a rear perspective view of the present invention;

FIG. 3 is a block diagram showing the configuration of the components of the present invention;

FIG. 4 is a schematic view of the present invention when in use;

FIG. 5 is a schematic view of the present invention when in use, showing the machine body is moved and turned to purify the air; and

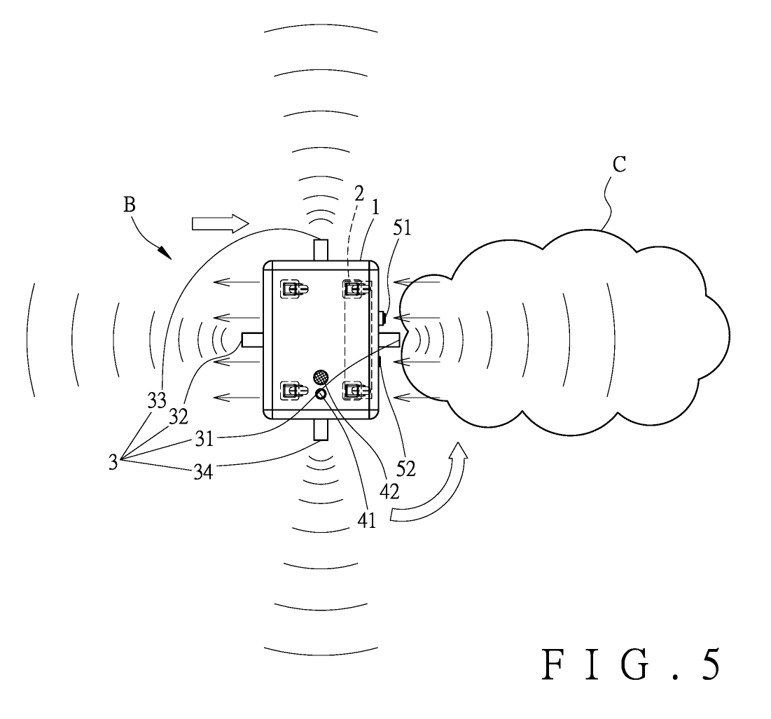

FIG. 6 is a schematic view of the present invention when in use, showing a smart phone is used to monitor the home situations.

### DETAILED DESCRIPTION OF THE PREFERRED EMBODIMENTS

Embodiments of the present invention will now be described, by way of example only, with reference to the accompanying drawings.

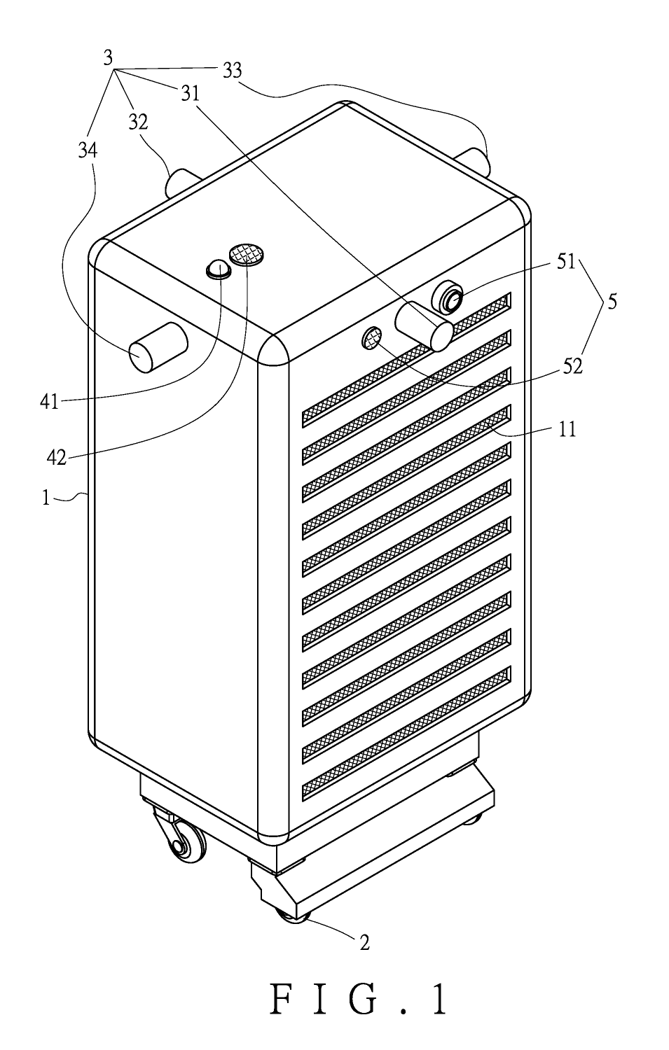

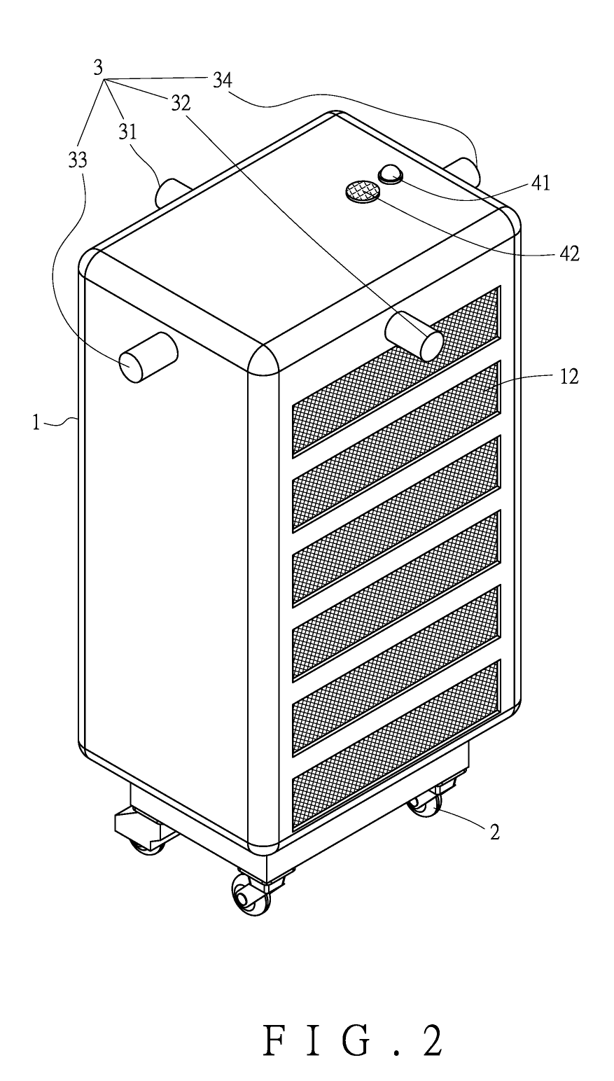

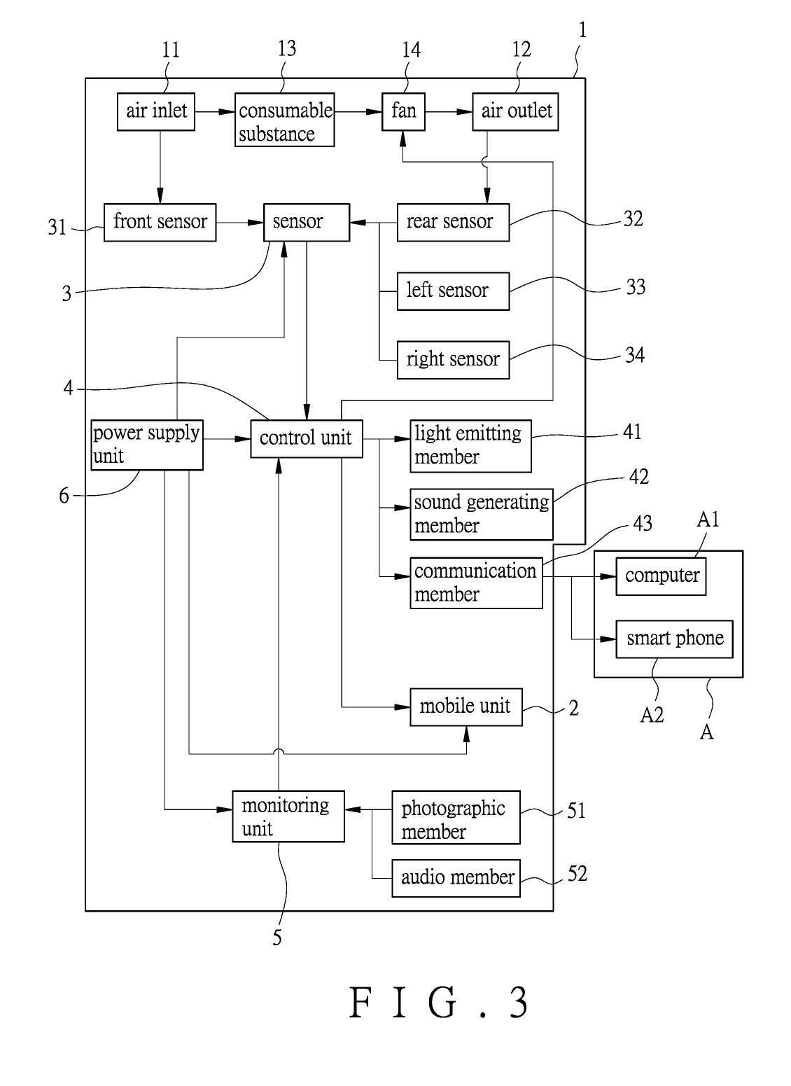

As shown in FIG. 1, FIG. 2, and FIG. 3, the intelligent air purifier in accordance with a preferred embodiment of the present invention comprises a machine body 1, a mobile unit 2, at least one sensor 3, a control unit 4, a monitoring unit 5, and a power supply unit 6.

The machine body 1 can be moved in a room 11. A front side of the machine body 1 has an air inlet 11. A rear side of the machine body 1 has an air outlet 12. Two sides of the machine body 1, between the air inlet 11 and the air outlet 12, are defined as a left side and a right side, respectively. The interior of the machine body 1, between the air inlet 11 and the air outlet 12, is provided with a consumable substance 13 and a fan 14. The consumable substance 13 is selectable according to different gas compositions contained in the air sucked through the air inlet 11 in the room. The consumable substance 13 needs to be periodically replaced. When the fan 14 is actuated, the air in the room is sucked through the air inlet 11 to be purified by the consumable substance 13 and then discharged through the air outlet 12.

The mobile unit 2 is disposed at the bottom of the machine body 1. The mobile unit 2 may be a wheel or a continuous track. The wheel or the continuous track is driven by an engine or a motor to move the machine body 1 within the room through a belt, a belt pulley, a gear, a chain or a pulley. In this embodiment, the mobile unit 2 moves the machine body 1 forward or backward with a wheel near the front side of the machine body 1 as a power wheel, and the mobile unit 2 turn the machine body 1 left or left with a wheel near the rear side of the machine body 1 as a turning wheel.

The at least one sensor 3 is used to detect an air quality index of the air in the room. The sensor 3 may be one of a dust concentration sensor, a PM2.5 sensor, a carbon dioxide concentration sensor, a carbon monoxide concentration sensor, an ammonia concentration sensor, a sulfur dioxide concentration sensor, a TVOC (Total Volatile Organic Compounds) concentration sensor, a hydrogen sulfide concentration sensor, an alcohol concentration sensor, a formaldehyde concentration sensor, a chlorofluorocarbon concentration sensor, a vehicle exhaust concentration sensor, a combustible gas concentration sensor, a liquefaction petroleum gas concentration sensor, and a methane concentration sensor, or a combination thereof. The sensor 3 is selectable and replaceable according to the different gas compositions contained in the air to be purified. In this embodiment, the sensor 3 includes a front sensor 31, a rear sensor 32, a left sensor 33, and a right sensor 34. The front sensor 31 is disposed on the front side of the machine body 1 corresponding in position to the air inlet 11 for detecting the air quality index of the air before the air is sucked into the air inlet 11. The rear sensor 32 is disposed on the rear side of the machine body 1 corresponding in position to the air outlet 12 for detecting the air quality index of the air purified by the consumable substance 13 and discharged from the air outlet 12. The left sensor 33 is disposed on the left side of the machine body 1 for detecting the air quality index of the air at the left side of the machine body 1. The right sensor 34 is disposed on the right side of the machine body 1 for detecting the air quality index of the air at the right side of the machine body 1.

The control unit 4 is disposed in the machine body 1. The control unit 4 is communicated with the fan 14, the mobile unit 2, the front sensor 31, the rear sensor 32, the left sensor 33, and the right sensor 34 through electrical signals. The control unit 4 is capable of controlling the actuation of the mobile unit 2 to move or to turn the machine body 1 in the room. The fan 14 is actuated by the control unit 4 to purify the air in the room. The control unit 4 may be a single chip control module, a transistor control module, or a computer control module. The control unit 4 compares a pre-purification datum of the air detected by the front sensor 31 before the air is sucked into the air inlet 11 with a post-purification datum of the air discharged from the air outlet 12 and detected by the rear sensor 32. After comparison, if the discrepancy between the pre-purification datum and the post-purification datum is too large and greater than a replacement standard value, it means that the purification effect is poor. The consumable substance 13 fails and needs to be replaced. The control unit 4 controls a light emitting member 41 to light up or blink, and controls a sound generating member 42 to generate a warning sound, thereby notifying the user of replacing the consumable substance 13. The light emitting member 41 and the sound generating member 42 are disposed on the machine body 1. The control unit 4 controls the rotational speed of the fan 14 according to the air quality index of the detected air, and controls the movement speed of the mobile unit 2, thereby change the purification rate for the air C in order to purify the air rapidly.

The control unit 4 determines whether or not the air quality index of the left side or the right side of the machine body 1 is greater than a pollution value according to the air quality index of the air at the left side of the machine body 1 detected by the left sensor 33 and the air quality index of the air at the right side of machine body 1 detected by the right sensor 34. If the air quality index is greater than the pollution value, it means that the air at the left side or the right side of the machine body 1 needs to be purified. The mobile unit 2 is actuated by the control unit 4 to turn the machine body 1 left or right, and the machine body 1 is moved to the position close to the polluted air. The air inlet 11 faces the position to purify the air, such that the air can be purified quickly.

The control unit 4 can control the suction force of the air inlet 11 according to the air quality index and controls the movement speed of the mobile unit 2 so as to control the purification rate for the air.

The control unit 4 is provided with a communication member 43. The communication member 43 may be a network, a Bluetooth or a Wi-Fi for performing transmission.

The monitoring unit 5 is disposed on the machine body 1. The monitoring unit 5 is communicated with the control unit 4 through electrical signals. The monitoring unit 5 includes a photographic member 51 and/or an audio member 52. In this embodiment, the monitoring unit 5 includes both the photographic member 51 and the audio member 52 for photographing and recording a sound in the room. The control unit 4 transmits a captured image and/or a recorded sound through the communication member 43, namely, the network, the Bluetooth or the Wi-Fi, to a remote electronic device A to be monitored. The electronic device A may be a computer A1 or a smartphone A2.

The power supply unit 6 is disposed in the machine body 1. The power supply unit 6 is electrically connected with the mobile unit 2, the sensor 31, the control unit 4, and the monitoring unit 5, thereby supplying the required power for the mobile unit 2, the sensor 3, the control unit 4, and the monitoring unit 5. The power supply unit 6 may be a rechargeable battery or a power cord connected with the mains supply.

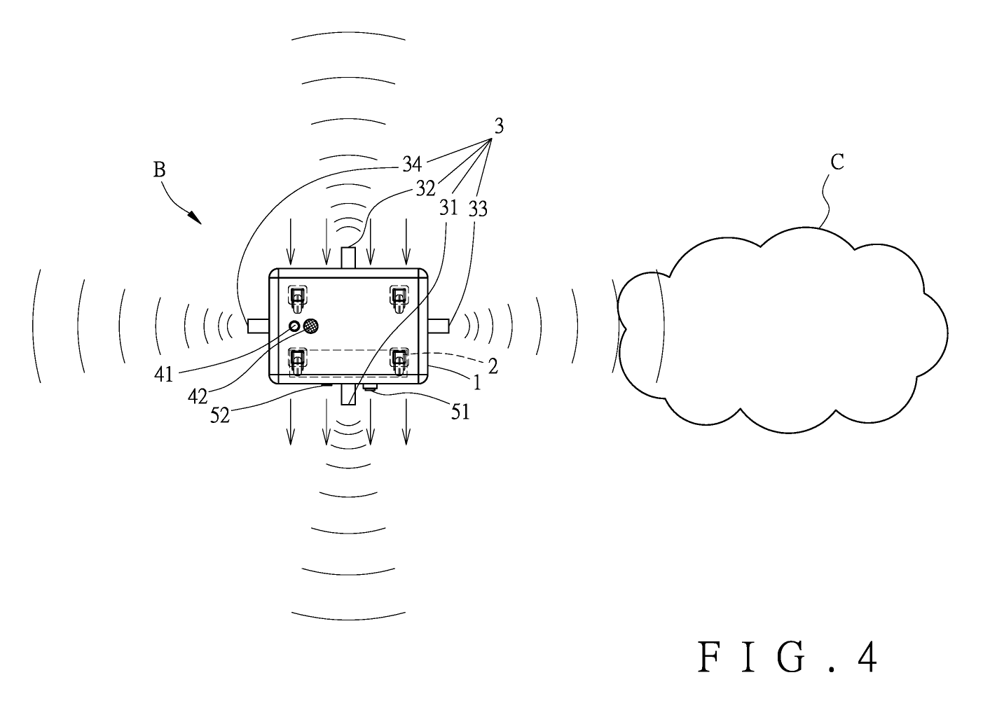

When in use, the machine body 1 is placed in the room B, as shown in FIG. 1, FIG. 3 and FIG. 4. First, the mobile unit 2 is actuated by the control unit 4 to move the machine body 1 freely in the room. When the air quality index of the air C detected by the front sensor 31, the rear sensor 32, the left sensor 33, or the right sensor 34 on the machine body 1 at any position of the room B is greater than the pollution value preset by the control unit 4, the control unit 4 will actuate the mobile unit 2 to move the machine body 1 forward or rearward or to turn the machine body 1 left or right to the position, and the air inlet 11 faces the position where the air quality index is greater than the pollution value to purify the air C.

The control unit 4 can control the rotational speed of the fan 14 according to the air quality index of the air C to change the suction force of the air inlet 11, and can control the movement speed of the mobile unit 2. For example, when the air quality index of the air C is great, the fan 14 is turned at a high speed so that the suction force of the air inlet 11 is large, and the mobile unit 2 is moved slowly or stays for a long time to purify the air so that it has sufficient time to purify the air C. When the air pollution index of the air C is less, the fan 14 is turned at a low speed so that the suction force of the air inlet 11 is small, and the mobile unit 2 is moved quickly or stays for a while to purify the air so that it is fast to complete the purification of the air C. By changing the purification rate for the air C, the air can be purified in a fast manner.

As shown in FIG. 1, FIG. 2, and FIG. 3, the front sensor 31 detects the air quality index of the air C before sucked into the air inlet 11 anytime to generate the pre-purification datum while the machine body 1 is moved to purify the air C. The rear sensor 32 detects the air quality index of the air purified by the consumable substance 13 and discharged from the air outlet 12 anytime to generate the post-purification datum. The control unit 4 comparers the pre-purification datum with the post-purification datum. After comparison, if the discrepancy between the pre-purification datum and the post-purification datum is too large and greater than the replacement standard value, the control unit 4 controls the light emitting member 41 to light up or blink and controls the sound generating member 42 to generate a warning sound to notify the user of replacing the consumable substance 13, such that the consumable substance 13 can maintain the effect of purifying the air for a long period of time.

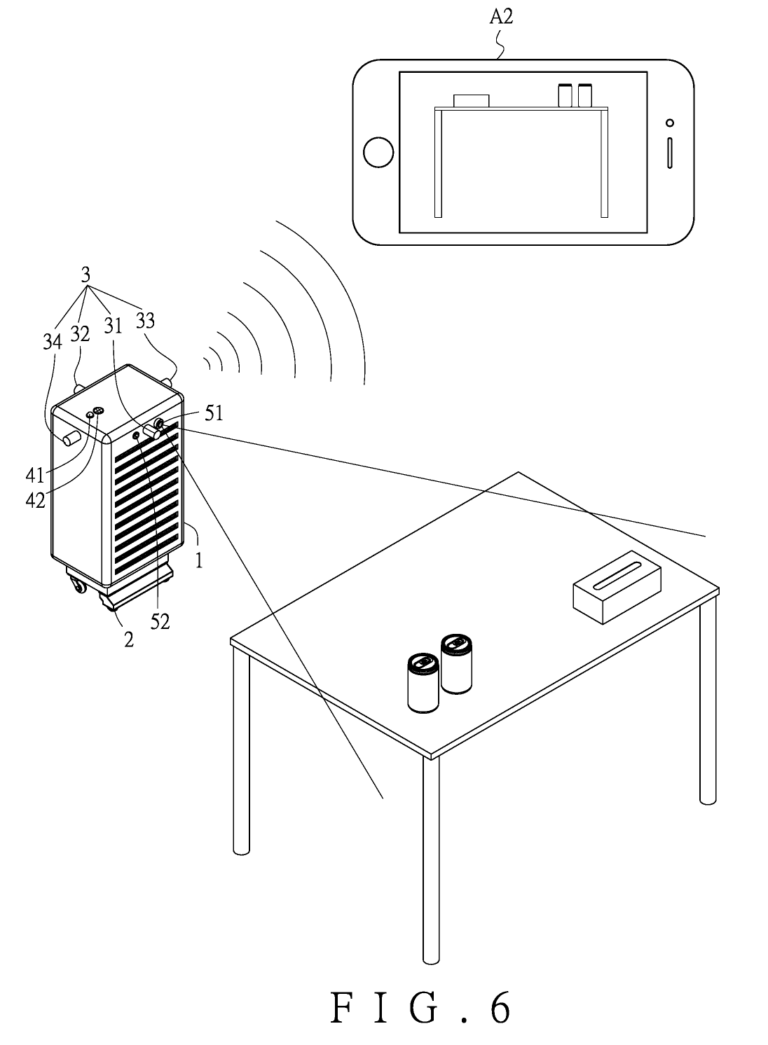

As shown in FIG. 1, FIG. 3, and FIG. 6, the photographic member 51 and the audio member 52 on the machine body 1 are used for photographing and recording a sound in the room anytime. The control unit 4 transmits a captured image and/or a recorded sound through the communication member 43, namely, the network, the Bluetooth or the Wi-Fi, to the remote electronic device A, so that the user can monitor the state of the room B anytime to prevent the intrusion of a thief or a fire, so that the user can know and monitor the home situations and ensure the home safety.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An intelligent air purifier, used for purifying air in a room, comprising:
a machine body, moved or turned in the room, the machine body having at least one air inlet and at least one air outlet, the air being sucked from the air inlet and discharged from the air outlet, the machine body being provided with a consumable substance;
a mobile unit, mounted to the machine body;
at least one sensor, disposed on the machine body for detecting an air quality index of the air; and
a control unit, disposed in the machine body, the control unit being communicated with the mobile unit and the senor through electrical signals, the control unit being preset with a pollution value; wherein when the air quality index of the air at a position in the room is greater than the pollution value, the control unit controls the mobile unit to move the machine body to the position and the air inlet faces the position to purify the air.

2. The intelligent air purifier as claimed in claim 1, wherein the air inlet is disposed at a front side of the machine body, the air outlet is disposed at a rear side of the machine body, and two sides of the machine body, between the air inlet and the air outlet, are defined as a left side and a right side, respectively.

3. The intelligent air purifier as claimed in claim 2, wherein the sensor includes a front sensor, a rear sensor, a left sensor, and a right sensor; the front sensor is disposed on the front side of the machine body corresponding in position to the air inlet for detecting the air quality index of the air before the air is sucked into the air inlet; the rear sensor is disposed on the rear side of the machine body corresponding in position to the air outlet for detecting the air quality index of the air purified by the consumable substance and discharged from the air outlet; the left sensor is disposed on the left side of the machine body for detecting the air quality index of the air at the left side of the machine body; and the right sensor is disposed on the right side of the machine body for detecting the air quality index of the air at the right side of the machine body.

4. The intelligent air purifier as claimed in claim 3, wherein the control unit compares a pre-purification datum of the air detected by the front sensor before the air is sucked into the air inlet with a post-purification datum of the air discharged from the air outlet and detected by the rear sensor to determine whether the consumable substance needs to be replaced or not.

5. The intelligent air purifier as claimed in claim 4, wherein when the control unit determines that it is necessary to replace the consumable substance, the control unit controls a light emitting member to light up or blink or controls a sound generating member to generate a warning sound, the light emitting member and the sound generating member are disposed on the machine body, respectively.

6. The intelligent air purifier as claimed in claim 3, wherein the control unit determines whether or not the air quality index of the air at the left side or the right side of the machine body is greater than the pollution value according to the air quality index detected by the left sensor and the air quality index detected by the right sensor, the air quality index of the air at the left side or the right side of the machine body is greater than the pollution value, the mobile unit is actuated by the control unit to move or turn the machine body left or right.

7. The intelligent air purifier as claimed in claim 1, wherein the consumable substance is disposed in the machine body and located between the air inlet and the air outlet.

8. The intelligent air purifier as claimed in claim 1, wherein the mobile unit is one of a wheel and a continuous track, the wheel or the continuous track is driven by one of an engine and a motor to move the machine body within the room through one of a belt, a belt pulley, a gear, a chain, and a pulley.

9. The intelligent air purifier as claimed in claim 1, wherein the sensor is one of a dust concentration sensor, a PM2.5 sensor, a carbon dioxide concentration sensor, a carbon monoxide concentration sensor, an ammonia concentration sensor, a sulfur dioxide concentration sensor, a TVOC (Total Volatile Organic Compounds) concentration sensor, a hydrogen sulfide concentration sensor, an alcohol concentration sensor, a formaldehyde concentration sensor, a chlorofluorocarbon concentration sensor, a vehicle exhaust concentration sensor, a combustible gas concentration sensor, a liquefaction petroleum gas concentration sensor, and a methane concentration sensor, or a combination thereof.

10. The intelligent air purifier as claimed in claim 1, wherein the control unit is one of a single chip control module, a transistor control module, and a computer control module.

11. The intelligent air purifier as claimed in claim 1, wherein a fan is provided between the air inlet and the air outlet, the fan is communicated with the control unit through electrical signals, the control unit controls a rotational speed of the fan according to the air pollution index of the air to change a suction force of the air inlet, and the control unit controls a movement speed of the mobile unit to change a purification rate for the air.

12. The intelligent air purifier as claimed in claim 1, further comprising a monitoring unit, the monitoring unit being communicated with the control unit through electrical signals, the monitoring unit including a photographic member and/or an audio member for photographing and/or recording in the room, the control unit transmitting a captured image and/or a recorded sound to a remote electronic device, the photographic member and/or the audio member being disposed on the machine body.

13. The intelligent air purifier as claimed in claim 12, wherein the control unit is provided with a communication member, the communication member is one of a network, a Bluetooth and a Wi-Fi for transmitting the captured image and/or the recorded sound to the remote electronic device.

14. The intelligent air purifier as claimed in claim 1, further comprising a power supply unit, the power supply unit being disposed in the machine body, the power supply unit being electrically connected with the mobile unit, the sensor, the control unit, and the monitoring unit, thereby supplying a required power to the mobile unit, the sensor, the control unit, and the monitoring unit.
